(19) United States
(12) Patent Application Publication
(10) Pub. No.: US 2006/0031569 A1
(43) Pub. Date: Feb. 9, 2006

(54) Load balancing system using mobile agents

(76) Inventors: Sasa Desic, Zagreb (HR); Darko Huljenic, Zagreb (HR); Ignac Lovrek, Zagreb (HR)

Correspondence Address: ERICSSON INC., 6300 LEGACY DRIVE, M/S EVR C11, PLANO, TX, 75024, US

(21) Appl. No.: 10/519,289

(22) PCT Filed: Jul. 3, 2002
(86) PCT No.: PCT/EP02/07385

§ 371 Date: Aug. 1, 2005

(51) Int. Cl. G06F 15/173

(52) U.S. Cl. 709/238

(57) ABSTRACT

A method for managing the respective processing loads of a plurality of processors in a network using a load balancing technique for load balancing, in which: a first network management processor issues a processing load information collection message to an adjacent processor, said adjacent processor adds into the message its analysed processing load information and forwards said message to yet another processor of the processor network which repeats the adding and forwarding functions, until one processor forwards the message with the added processing load information to the first network management processor, which determines, on the basis of the processing load information of the processors stored in said processing load information collection message a load balancing technique for load distribution among the processors in said processor network.

### FIELD OF THE INVENTION

The present application relates to a method and system for balancing the load in a network structure.

### BACKGROUND OF THE INVENTION

It is increasingly common for a plurality of computers, or other processing devices to be connected together in a network for the exchange of data, and the sharing of tasks. For example, a website may be made available to access over that internet by a plurality of web servers connected together in a network, wherein requests for information from the internet are divided amongst the servers so as to offer an increased ability to deal with numerous requests for information than could be provided by a single server. Mechanisms exist in such arrangements, whereby if one of the said servers receives an excess of requests for data from the Internet, requests are forwarded to another server in the local network, which may be better able to deal with the excess service requests. Similarly, where a plurality of connections exist between processors in a network, it may be appropriate to monitor the data transmission demands placed on the connections themselves, such that alternative communications routes can be employed where an excess of traffic is detected. Such techniques are known as load balancing. In the prior art, a load balancing system may be provided with one or two pre-defined load balancing mechanisms, which may be devised based upon average measurements of service demands received by the processors over time. However, this approach may be found to be unsatisfactory where the rate at which request for data are received varies rapidly and over a wide range, such that it is impossible to provide a predefined mechanism capable of dealing with all situations that arise. Furthermore, where the number of service requests received is so high as to exceed the total capacity of the network as a whole, the presence of predefined load balancing mechanisms may be found to cause a further deterioration in the performance of the system as a whole, since processing time and communication channel band widths are wasted on the processing of the load balancing mechanisms, and the forwarding of service requests from one server to another within the network.

An attempt to address these problems is provided by so called adaptive load balancing mechanisms, which apply a predefined set of rules to determine the best manner of dealing with incoming service requests at a particular server. Nonetheless, the dependence on predetermined rules beings with it an inherent lack of flexibility, resulting in poor performance under unusual or unpredictable network conditions.

### SUMMARY OF THE INVENTION

According to the present invention from a first aspect there is provided a method for managing the respective processing loads of a plurality of processors networked in a processor network using a load balancing technique for load balancing, in which: a first network management processor issues a processing load information collection message to an adjacent processor, said adjacent processor adds into the message its analysed processing load information and forwards said message to yet another processor of the processor network which repeats the adding and forwarding functions, wherein one processor forwards the message with the added processing load information to the first network management processor, which determines, on the basis of the processing load information of the processors stored in said processing load information collection message, a load balancing technique for load distribution among the processors in said processor network.

In the context of the present invention the expression load balancing technique relates to the selection and implementation of one or more load balancing mechanisms at a plurality of processors in a network, so as to bring about a coordinated response to the processing load demands on the network as a whole. A load balancing mechanism is a predefined set of instructions which will cause the processor on which they are implemented to deal with service requests in a particular way, such as forwarding excess service requests beyond a defined thresh hold to another processor, rejecting requests out right and so on. By employing a load balancing technique, the overall efficiency of the network can be considerably improved. By way of example, a load balancing technique may be determined which attempts to maintain an even level of processing effort at each processor, despite uneven distribution of outside service requests received at the different processors, by implementing load balancing mechanisms at the processors experiencing a high level of service requests which allow them to pass excess requests to less busy processors.

According to a development of this first aspect of the invention, the processing load information collection message is a first processing load exploration program unit, wherein said processing load exploration program unit analyses the respective processing load of each of the processors to which it is forwarded and stores corresponding processing load information.

According to a further development of this first aspect of the invention the first network management processor determines as said load balancing technique a respective load balancing method for each of said processors.

According to a further development of this first aspect of the invention, at least one of said processors has stored a plurality of load balancing methods and said first network management processor sends a load balancing method activation message to said at least one processor for activating the load balancing method determined for the processor.

According to a further development of this first aspect of the invention, prior to said first network management processor sending said load balancing method activation message to said at least one processor for activating the load balancing method determined for the processor, said first network management processor determines whether said load balancing method determined for the processor is presently stored at said processor.

According to a further development of this first aspect of the invention, the first network management processor sends to at least one processor, a load balancing method implementation message including the respective determined load balancing method and said at least one processor implements and activates said included load balancing method.

According to a further development of this first aspect of the invention the first processing load exploration program unit determines at each processor whether the processor is a network management processor or not.

According to a further development of this first aspect of the invention the first processing load exploration program unit is passed from processor to processor in accordance with a predetermined order of processors.

According to a further development of this first aspect of the invention the first processing load exploration program unit is passed from processor to processor in a predetermined group of processors.

According to a further development of this first aspect of the invention, at least one further processing load exploration program unit is passed from processor to processor in parallel with said first processing load exploration program unit.

According to a further development of this first aspect of the invention the first processing load exploration program unit and said further processing load exploration program unit are passed from processor to processor in different sequences.

According to a further development of this first aspect of the invention the plurality of processors comprises at least one further network management processor.

According to the present invention from a second aspect there is provided a network including a network management processor and a plurality of networked processors and having incorporated a load balancing technique for managing processing loads amongst said networked processors, characterised in that
a) a processing load information collection message is provided including an instruction unit for initiating an analysis of processing loads at a processor and a storage unit for storing processing load information about the analysed processing loads;
b) each processor has a reception unit for receiving said processing load information collection message, processor for running said received exploration program unit, and transmission unit for forwarding said processing load information collection message to a next processor; and
c) said network management processor has a transmission unit for transmitting said processing load information collection message to a first processor in the processor network, and a reception unit for receiving said processing load information collection message from a processor and a determining unit to determine, on the basis of the processing load information of the processors stored in said load exploration program unit storage section, a load balancing technique for load distribution among the processors in said processor network.

According to a further development of this second aspect of the invention, the processing load information collection message is a processing load exploration program unit, and said instruction unit of said processing load information collection message is an analysis program unit for performing an analysis of processing loads at a processor, and wherein said instruction unit of said processing load information collection message also causes the determining unit of said network management processor to determine said load balancing technique.

According to a further development of this second aspect of the invention, the network management processor has a determining unit to determine as said load balancing technique a respective load balancing method for each of said processors.

According to a further development of this second aspect of the invention, at least one of said processors has a storage unit to store a plurality of load balancing methods, and said network management processor is adapted to send a load balancing method activation message to said at least one processor for activating the load balancing method determined for the processor.

According to a further development of this second aspect of the invention, the network management processor has a transmission unit to send to at least one processor a load balancing method implementation message including the respective determined load balancing method, and said at least one processor has a receiver unit to receive an to implement and activate said included load balancing method.

According to a further development of this second aspect of the invention, the transmission unit and said reception unit of each of said processors respectively is adapted such that said processing load exploration program-unit is passed from processor to processor in accordance with a predetermined order of processors.

According to a further development of this second aspect of the invention, the transmission unit and said reception unit of each of said processors respectively is adapted such that said processing load exploration program unit is passed from processor to processor in a predetermined group of processors.

According to the present invention from a third aspect there is provided a processing load information collection unit for use in the management of the respective processing loads of a plurality of processors networked in a processor network using a load balancing technique for load balancing and having network management processor, said processing load exploration collection unit comprising

storage section, and instruction section, said instruction section further comprising:
a) a forwarding control section to cause said network management processor to issue said processing load information collection message to a first one of said plurality of processors, and then to cause each one of said plurality of processors to pass said processing load information collection unit to a further one of said plurality of processors respectively until it arrives again at said network management processor, and
b) an analysis section to analyse the respective processing load of each of said processors (to which it is forwarded on its reception thereby, the results of each such analysis being stored in said storage section, and
c) a load balancing technique selection section to cause said network management processor on its reception thereby to determine, on the basis of the processing load information of the processors stored in said storage section, a load balancing technique for load distribution among the processors in said processor network.

According to a further development of this third aspect of the invention, said instruction section comprises a program unit which when executed on the respective processors;
a) causes said network management processor to issue said processing load information program unit to a first one of said plurality of processors, and then to cause each one of said plurality of processors to pass said processing load information program unit to a further one of said plurality of processors respectively until it arrives again at said network management processor,
b) analyses the respective processing load of each of said processors to which it is forwarded on its execution thereby, the results of each such analysis being stored in said storage section, and
c) causes said network management processor on its execution thereby to determine, on the basis of the processing load information of the processors stored in said storage section, a load balancing technique for load distribution among the processors in said processor network

According to a further development of this third aspect of the invention, the processing load information collection unit causes said network management processor on its execution thereby to determine, on the basis of the processing load information of the processors stored in said storage section, a load balancing technique for load distribution among the processors in said processor network, for each of said processors.

According to a further development of this third aspect of the invention, the processing load exploration program unit further causes said network management processor on its execution thereby after said step of determining a load balancing technique, to send a load balancing method activation message to said at least one processor for activating the load balancing method determined for the processor.

According to a further development of this third aspect of the invention, the processing load exploration program further causes said network management processor on its execution thereby, after said step of determining a load balancing technique, to send to at least one processor a load balancing method implementation message including the respective determined load balancing method, and said at least one processor implements and activates said included load balancing method.

According to a further development of this third aspect of the invention, the processing load exploration program unit further has a determining unit to determine at each processor whether the processor is said network management processor or not.

According to a further development of this third aspect of the invention, said instruction section of the processing load exploration program unit is adapted to cause each one of said plurality of processors to pass said processing load exploration program unit to a further one of said plurality of processors respectively in accordance with a predetermined order of processors.

According to a further development of this third aspect of the invention, said instruction section of the processing load exploration program unit is adapted to cause each one of said plurality of processors to pass said processing load information collection message to a further one of said plurality of processors respectively in a predetermined group of processors.

### BRIEF DESCRIPTION OF THE DRAWINGS

For a better understanding of the invention, and to show how the same may be carried into effect, reference will now be made, by way of example, to the accompanying drawings, in which:

FIG. 1 shows a load balancing method according to a first embodiment of the present invention;

FIG. 2 shows a load balancing method according to a second embodiment of the invention;

FIG. 3 shows a load balancing method according to a third embodiment of the invention;

FIG. 4 shows a load balancing method according to a fourth embodiment of the invention;

FIG. 5 shows a load balancing mechanism according to a fifth embodiment of the invention;

FIG. 6 shows a load balancing method according to a sixth embodiment of the invention;

FIG. 7 shows a load balancing method according to a seventh embodiment of the invention;

FIG. 8 shows a load balancing method according to a eighth embodiment of the present invention;

FIG. 9 shows a load balancing method according to a ninth embodiment of the present invention;

FIG. 10 shows a load balancing method according to a tenth embodiment of the present invention;

FIG. 11 shows a load balancing method according to a eleventh embodiment of the present invention;

FIG. 12 shows a load balancing system according to a twelfth embodiment of the invention;

FIG. 13 shows a load balancing system according to a thirteenth embodiment of the invention;

FIG. 14 shows a load balancing method according to a fourteenth embodiment of the invention;

FIG. 15 shows a load balancing system method according to a fifteenth embodiment of the present invention;

FIG. 16 shows a load balancing system method according to a twelfth embodiment of the present invention;

FIG. 17 shows a load balancing system according to a thirteenth embodiment of the present invention;

FIG. 18 shows a load balancing system according to a sixteenth embodiment of the present invention;

FIG. 19 shows a load balancing system according to a seventeenth embodiment of the present invention;

FIG. 20 shows a load balancing unit according to an eighteenth embodiment of the present invention;

FIG. 21 shows a load balancing unit according to a nineteenth embodiment of the present invention;

FIG. 22 shows a load balancing method according to a twentieth embodiment of the present invention;

FIG. 23 shows a load balancing method according to a ninth embodiment of the present invention;

FIG. 24 shows a load balancing method according to a tenth embodiment of the present invention;

FIG. 25 shows a load balancing method according to a eleventh embodiment of the present invention;

Throughout the drawings like reference numerals denote like elements.

### DETAILED DESCRIPTION OF THE PREFERRED EMBODIMENTS

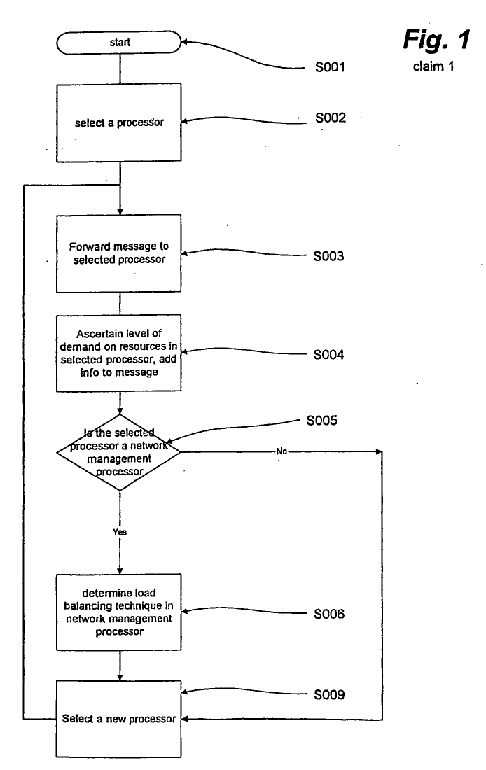

FIG. 1 shows a load balancing method according to a first embodiment of the present invention. This method relates to the management of the respective processing loads of a plurality of processors, which are connected together in a network. The method comprises the steps of selecting one of the processors in the network, at step S002, and forwarding a processing load information collection message 21 to the selected processor.

The selected processor receives the processing load information collection message 21, and after the level of demand on resources of the selected processor is ascertained, this information is added to the processing load information collection message. It is further determined whether the selected to which the processing load information collection message has been forwarded is a processor having network management functions. If it is found that the selected processor is a network management processor, at step S005, the method proceeds to step S006, at which a load balancing technique is selected for the balancing of the loading of the network as a whole. Before proceeding to step S009, at which a new processor is selected. Where it is detected at step S005 that the selected processor does not have management functions, the method proceeds directly to step S009 of selecting a new processor. Once a new processor has been selected at step S009, the method returns to step S003, where that processing load information collection message 21 is forwarded to the newly selected processor. This sequence of steps may be repeated indefinitely, or at such times that it is determined that it is desirable to reassess the load balancing situation of the network.

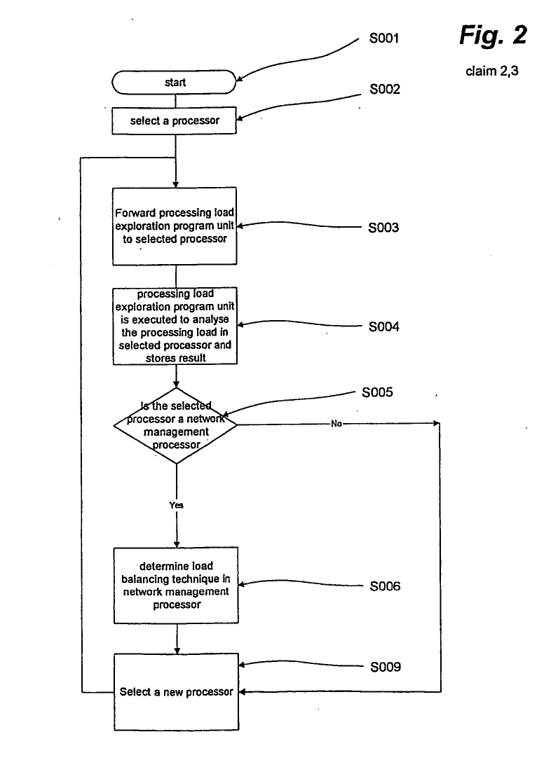

FIG. 2 shows a load balancing method according to a second embodiment of the invention. The method of FIG. 2 is similar to that of FIG. 1, in that it comprises the same steps S001 of starting the method, S002 of selecting a processor, S005 of determining whether the selected processor is a network processor is a network management processor, S006 of determining a load balancing technique, and S009 of selecting a new processor. However according to this method, the step S003 involves the forwarding of a processing load exploration program to the processor selected at step S002, and step S004 involves executing the processing load exploration programming unit, so as analyse the processing load in the selected processor, and storing the result in a part of the processing load exploration program unit. Thus, while the method of FIG. 1 merely discloses the triggering of various events by the arrival of a particular message, in the method of FIG. 2, it is the message itself, in the form of a processing load exploration programming unit, which is executed so as to carry out the various steps itself. As such, the use of the processing load exploration program unit, may be considered to equate to the use of agent technology.

Such an agent is a computer executable program, which can move autonomously through a network, and is provided with sufficient “intelligence” to perform certain defined actions. According to the invention, the agent migrates from node to node of the network, before returning to a home node, to report results. Such an intelligent agent has the ability to learn, and to change its response according to the experiences. For example, an agent could be adapted to change routing or DNS tables within a network node, in order to achieve load movement to likely loaded nodes or network links, or to make other changes so as to manage the loading of network elements to the optimum efficiency.

Such an agent has means to store data relating to the surroundings of the agent, and/or information relevant to the responsibilities or tasks of the agent. In the context of the present invention, intelligence may be defined to include the ability to interpret information gathered so as to identify what steps may lead to the desired outcome, without being constrained to a static set of rules. For example, where the agent observes that a desired standard of load balancing it achieved under a certain set of circumstances, the agent may automatically act so as to bring these circumstances about, without any pre-programmed information regarding the circumstances themselves. Although in practice the majority of agents knowledge is likely to be programmed, this information can be added to by tracking the events in the agents environment, and further by the monitoring of user actions and behaviour. Inferencing engines within agents can be used to generate new knowledge and conclusions from known facts, such that by continuous work and intelligence, qualitative improvement can be made to the system.

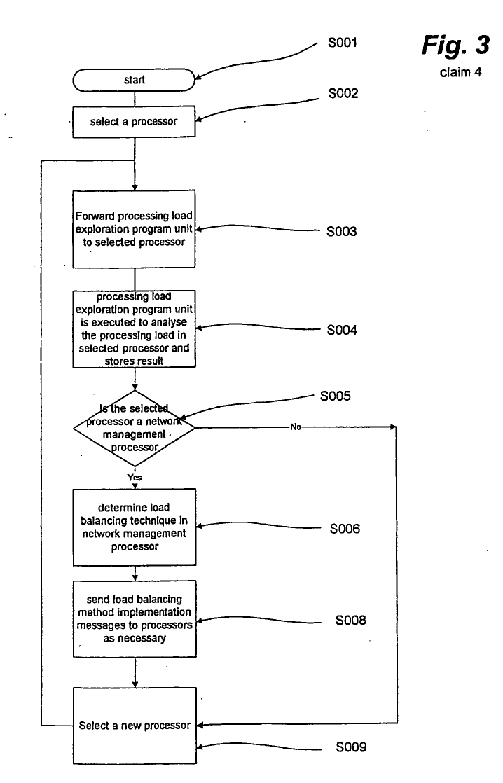

FIG. 3 shows a load balancing method according to a third embodiment of the invention. FIG. 3 comprises all of the same steps as discussed as with reference to FIG. 2. In the method of FIG. 3 however, there is further provided a step S008, between the step S006 of determining the load balancing technique, and step S009 of selecting a new processor. Step S008 involves the transmission of load balancing method implementation messages to one or more processors in a network as required. Thus, when the processing load exploration program unit is present in a network management processor, once it is determined what load balancing technique is appropriate to the load balancing condition of the network as a whole for example on the basis of load threshold criteria, or the variation of the loading of particular processors from a mean loading, the load exploration program unit further acts to activate the load balancing methods located in processors in the system so as to realise the load balancing technique selected.

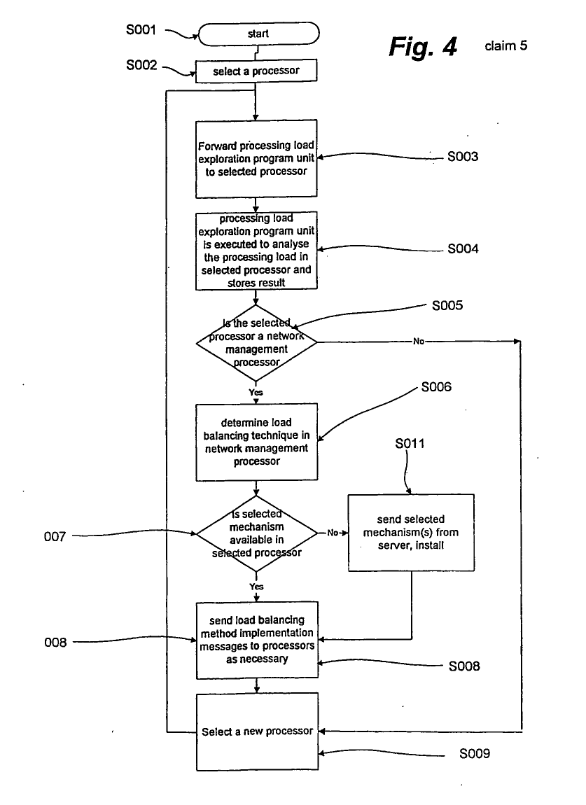

FIG. 4 shows a load balancing method according to a fourth embodiment of the invention. The method of FIG. 4 contains all of the same steps S001, S002, S003, S004, S005, S006, S008 and S009 of the method of FIG. 3. This method further comprises new steps S008 and S011. Step S007 is provided between steps S006, at which, when the exploration program unit is executed at a network management processor, a load balancing technique is determined, and step S008 at which load balancing method implementation messages are transmitted to processors throughout the network as required to activate the load balancing technique thus selected. At step S007, it is determined whether the mechanisms necessary for the implementation of the load balancing technique thus determined are present in the processors at which they are required by the newly determined load balancing technique. If it is found that all of the mechanisms are already present in the processors at which they are required, the method proceeds to step S008. Otherwise, the method proceeds to new step S011, at which the selected mechanisms which are not present at the processors at which they are required are transmitted to those processors, and installed therein. The method then proceeds to step S008 as discussed above.

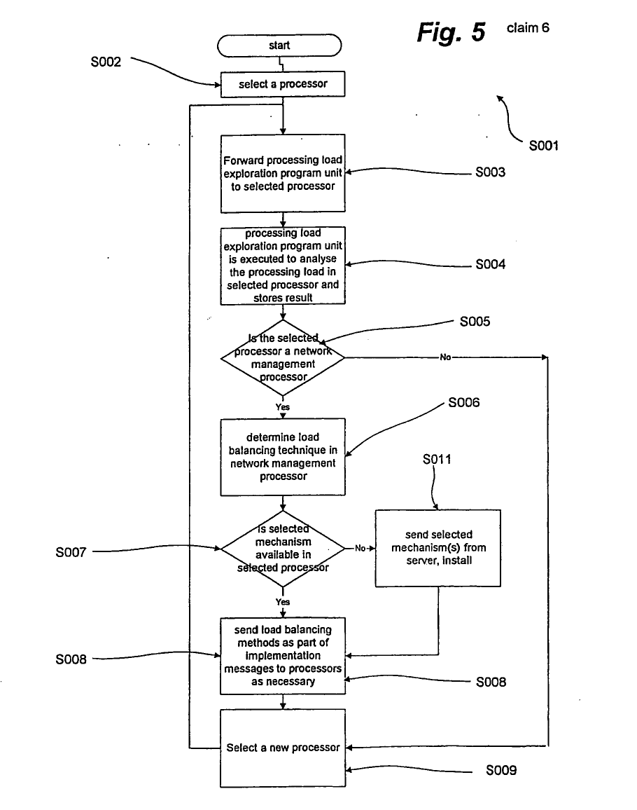

FIG. 5 shows a load balancing mechanism according to a fifth embodiment of the invention. The method of FIG. 5 comprises all of the same steps as the method of FIG. 4. However, according to the method of FIG. 5, at step S011, where it is detected that a selected mechanism is not available in a particular processor, the selected mechanism is incorporated into the respective implementation message destined for that particular processor, such that at step S008, when the load balancing method implementation messages are transmitted, they incorporate the mechanisms necessary for the realisation of the selected load balancing technique.

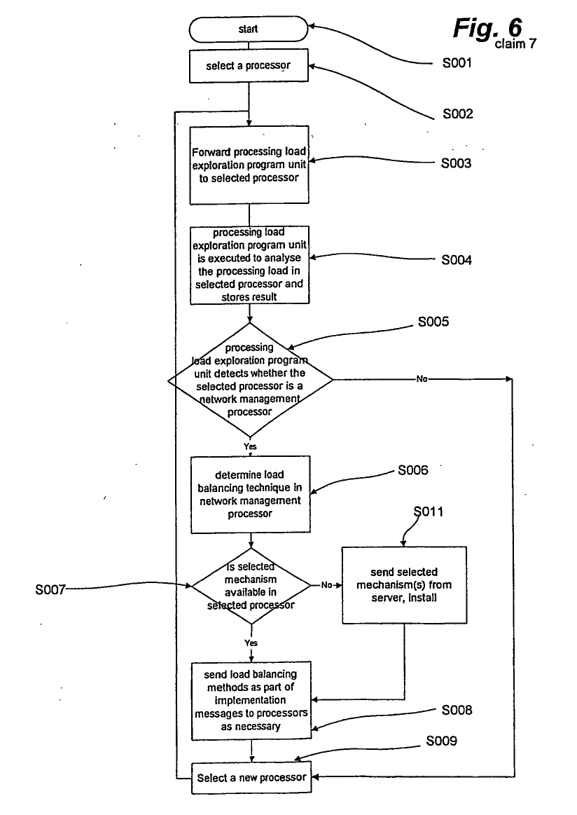

FIG. 6 shows a load balancing method according to a sixth embodiment of the invention. The method of FIG. 6 comprises all of the same steps as FIG. 5. However, according to the method of FIG. 6, at step S005, the task of determining whether the processor at which the processing load exploration program unit is presently found has network management functions, is actively determined by processing load exploration program unit when it is executed upon the respective processor.

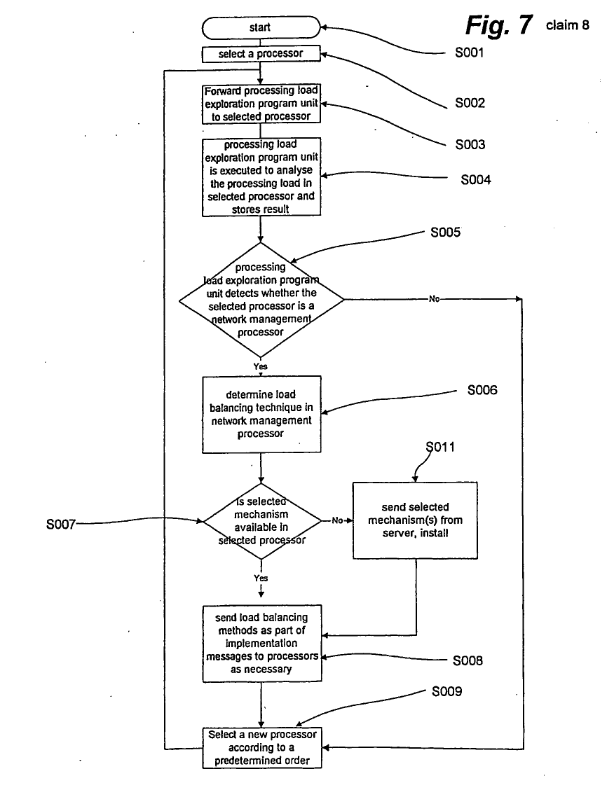

FIG. 7 shows a load balancing method according to a seventh embodiment of the invention. The method of FIG. 7 comprises all of the same steps as the method of FIG. 6. However, according to this method, at step S009, at which a new processor is selected to which the processing load exploration program unit is to be forwarded, the new processor is selected according to a predetermined order, such that the processing load exploration program unit moves through the network according to a predetermined route.

FIG. 8 shows a load balancing method according to a eighth embodiment of the present invention. The method of FIG. 8 comprises all of the same steps as the method of FIG. 7. According to the method of FIG. 8 however at the step of S009, at which a new processor is selected to which the processing load exploration program unit is to be forwarded, the new processor is selected from a predetermined group of processors. This group may comprise a subset of the processors in the network as a whole, and may include for example only those processors from which services can be requested from the outside, or only processors concerned with the execution of a particular set of functions.

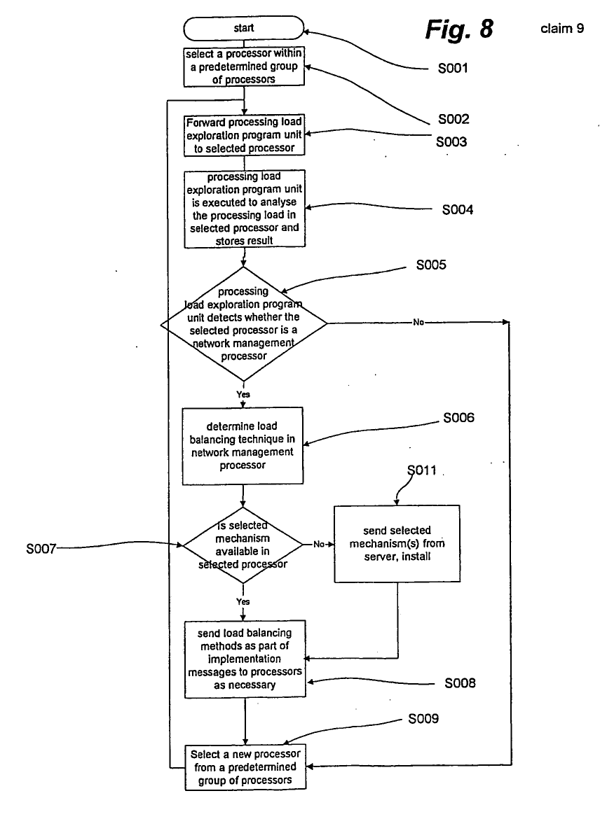

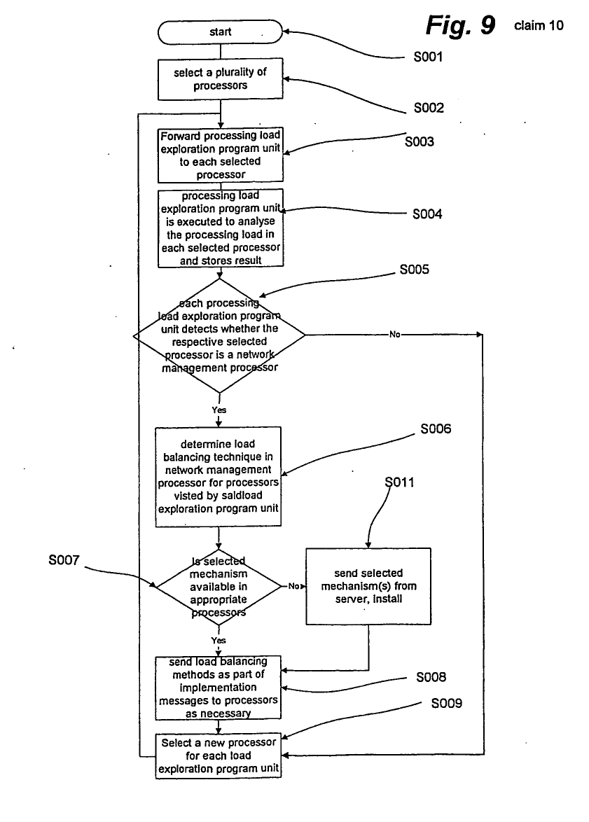

FIG. 9 shows a load balancing method according to a ninth embodiment of the present invention. The method of FIG. 9 corresponds essentially to the method of FIG. 6. However, according to this embodiment of the invention, a plurality of processing load exploration program unit exist in a network simultaneously. Thus, at step S002, a plurality of processors are selected, at S003, a processing load exploration unity is forwarded to each of the processors selected at S002, the processing load exploration program unit it executed in each selected processor to analyse the respective processing load thereof, it is further determined by each processing load exploration program unit whether the processor in which it is presently located has network functions, and at step S009, a new processor is respectfully requested for each of the plurality of load exploration program units.

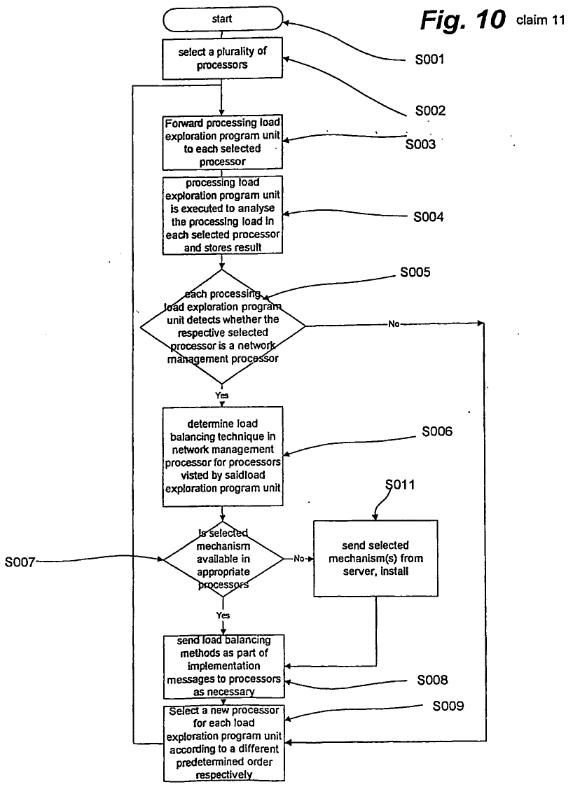

FIG. 10 shows a load balancing method according to a tenth embodiment of the present invention. The method of FIG. 10 comprises all of the same steps of the method of FIG. 9, however, according to this method at step S009, which a new processor is selected as the new destination for each load exploration program unit respectively, the new destination is selected according to predetermined order for each of the plurality of processing load exploration units. Thus, according to this embodiment of the invention, there will exist a plurality of processing load exploration units moving through the network along different predetermine paths.

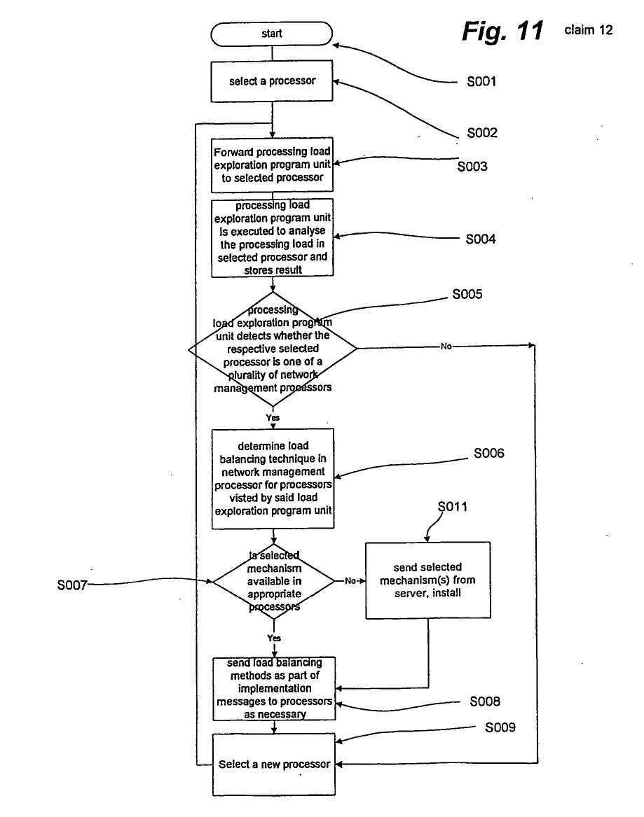

FIG. 11 shows a load balancing method according to a eleventh embodiment of the present invention. FIG. 11. The method of FIG. 11 comprises all of the same steps as the method of FIG. 6. However, according to this embodiment of the preset invention, it is envisaged that the network may comprise a plurality of network management processors, such that at step S005, the processing load exploration program unit detects whether the processor upon which it is executed is one of a plurality of network management processors. Where this is found to be the case, at step S006, a load balancing technique is selected for processors visited by the load exploration program unit. It may be, that the processors for which the load balancing technique is selected constitute a subset of the processors in the network, and further this subset may correspond to those processors being best disposed to receive load balancing technique instructions from the particular network management processor upon which the load exploration program unit is executed. For example, the load balancing technique may only be determined for those processors in the network directly connected to the network management processor upon which the load exploration program unity is executed.

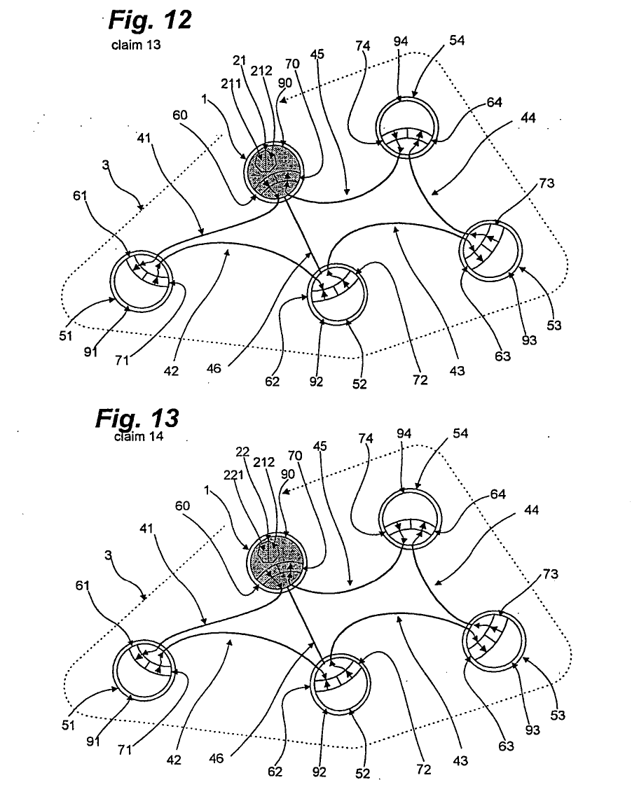

FIG. 12 shows a load balancing system according to a twelfth embodiment of the invention. FIG. 12 shows a network including a network management processor 1 and a plurality of network processors 51, 52, 53 and 54. There is provided a processing load information collection message 21, which includes an instruction unit 211, for initiating an analysis of processing loads at a processor, and a storage unit 212 for storing processing load information about the analysed processing loads. Each processor has a reception unit 60, 61, 62, 63, 64 for receiving said processing load information collection message 21, a processor 91, 92, 93, 94 for processing said processing load information collection message, and a transmission unit 70, 71, 72, 73, 74 for forwarding said processing load information collection message 21 to another processor in the network. The network management processor 1 is also provided with a transmission unit 60 for transmitting the processing load information collection message to a first processor in the processor network, and a reception unit 70 for receiving said processing load information collection message 21 from a processor in the network, and a determining unit 90 to determine a load balancing technique for load distribution in the processors in the processor network on the basis the processing load information of the processors stored in said load exploration program unit storage section 212. The processors 1, 51, 52, 53 and 54 are connected by data transmission channels 41, 42, 43, 44, 45 and 46.

Thus in operation, the processing load information collection message 21 is passed from processor to processor, through the communication channels 41, 42, 43, 45 and 46, triggering an analysis of processing load at each processor and storing the result of the analysis in the storage section of the processing load information collection message 212, before it is transmitted to the next processor in the network. When the processing load information collection message 21 finally arrives at the network management processor 1, the determining unit 90 can determine on the basis of the processing load information stored in the storage unit 212 of the processing load information collection message 21, what load balancing technique should be applied to the network.

FIG. 13 shows a load balancing system according to a thirteenth embodiment of the invention. In the network shown in FIG. 13, the processing load information collection message 21 of FIG. 12 is a processing load exploration program unit 22, and the instruction unit 211 of the processing load information collection message is an analysis program unit 221. This analysis program unit 221 is able, when executed on any of the processors 1, 51, 52, 53, 54 of the network, to form an analysis of the processing load of that processor, and to store the result in the storage unit 212. The processing load exploration unit 22 is also able, when executed on a network management processor, to determine a load balancing technique suitable for the network on the basis of processing load information gathered at the processors on which the processing load exploration program unit has been run.

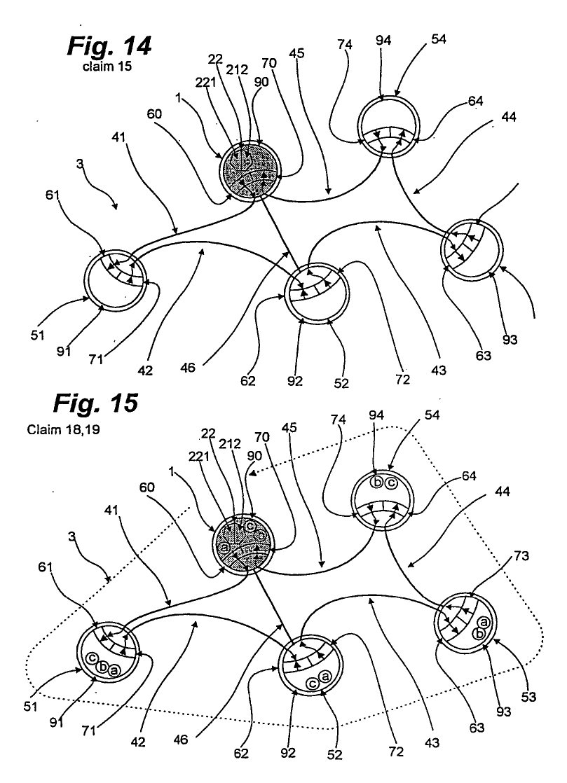

FIG. 14 shows a load balancing method according to a fourteenth embodiment of the invention.

FIG. 15 shows a load balancing system method according to a fifteenth embodiment of the present invention. In the network shown in FIG. 15, there are provided all of the same elements at in FIG. 13. According to this embodiment of the invention however, the reception units 70, 71, 72, 73 and 74 and the transmission units 60, 61, 62, 63 and 64, and the processing load exploration program unit 22 are adapted such that the program unit is passed from processor to processor in accordance with a predetermined order of processors as shown for example by the dashed line 3.

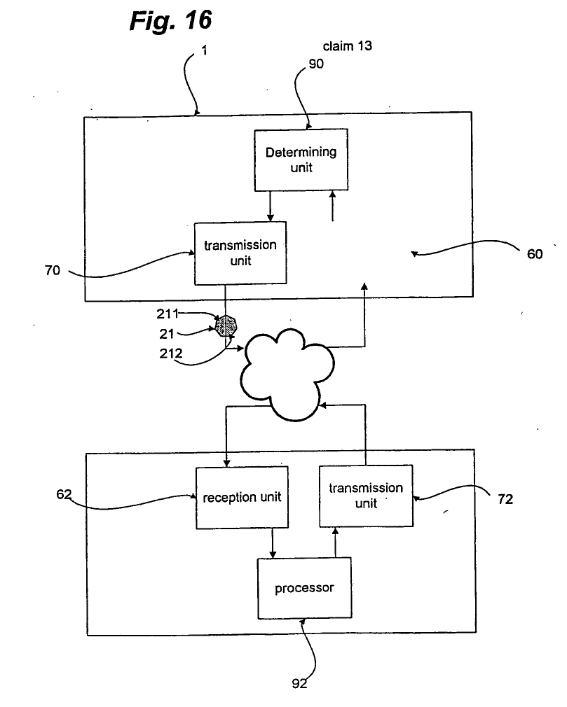

FIG. 16 shows a load balancing system according to a twelfth embodiment of the present invention. In the system as shown in FIG. 16, there is shown the determining means 90, transmission means 70 and reception means 60 of the network management processor 1, and the reception means-62, the transmission means 72, and the processing means 92 of a processor. Both the network management processor, 1 and the processor 62 are connected to a network 4. The transmission means of the network management processor 1 and the processor 62 are disposed so as to transmit data to the network 4, and the reception means of the network management processor and the processor 62 respectively are arranged to receive data from the network 4. The determining means 90 of the network management processor is connected to the transmission means 70 and the reception means 60 of the network management processor, and the processing means 92 of the processor 62 is connected to the reception means 62 and the transmission means 72 of the processor 52. A processing load information collection message 21 is depicted in transmission in the transmission means 70 of the network management processor 1 to the network 4. The processing load information collection message 21 is provided with an instruction unit 211 for initialling an analysis of processing loads at a processor, and a storage unit 212 for storing processing load information about the analyse processing loads.

Thus in operation as shown in FIG. 16, the processing load information collection message 21 is omitted from the network management processor 1 via the network 4 to a processor, in the case of the depicted example, processor 52. On reception by the reception means 62 of the processor 52, the processing load information collection message 21 is passed to the processing means of 92, which is triggered by the instruction unit 211 of the processing load information collection message 21 to perform an analysis of the processing load presently experienced by the processor 52. On completion of this analysis, the processing means 92 add the result of the analysis to the storage unit 212 of the processing load information collection message 21 before passing it to the transmission means 72 of the processor 52. The transmission means 72 then transmits the processing load information collections message 21 to a further processor, via the network 4.

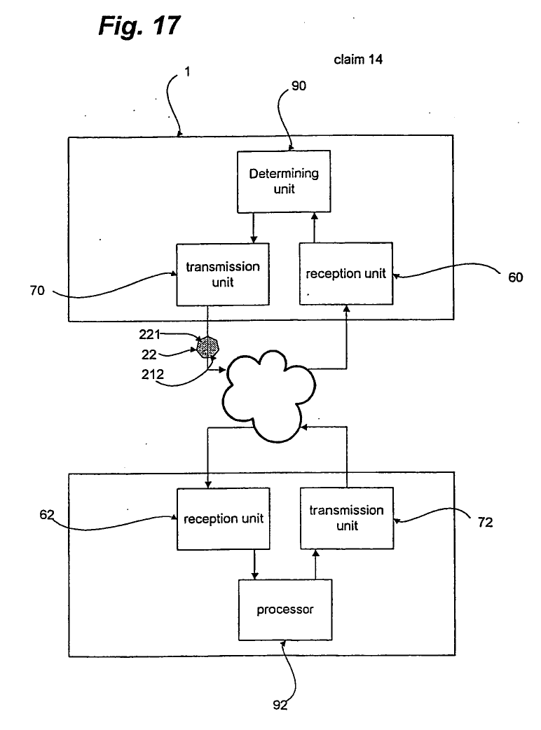

FIG. 17 shows a load balancing system according to a thirteenth embodiment of the present invention. In the embodiment of FIG. 17, there are provided all elements of the embodiment of FIG. 16, wherein the processing load information collection message 21 is in fact a processing load exploration information unit 22, and the instruction unit 211 of the processing load information collection unit is in fact an analysis program unit 221. The invention is carried out substantially as described with reference to FIG. 16, with the exception that rather than the analysis of the loading of the processor means 92 being simply triggered by the processing load information collection message 21, it is the execution of the instruction unit 211 stored in the processing load exploration program unit 22 which analysis the load level of the processor 52, and the storage of the results thereof in the storage 212.

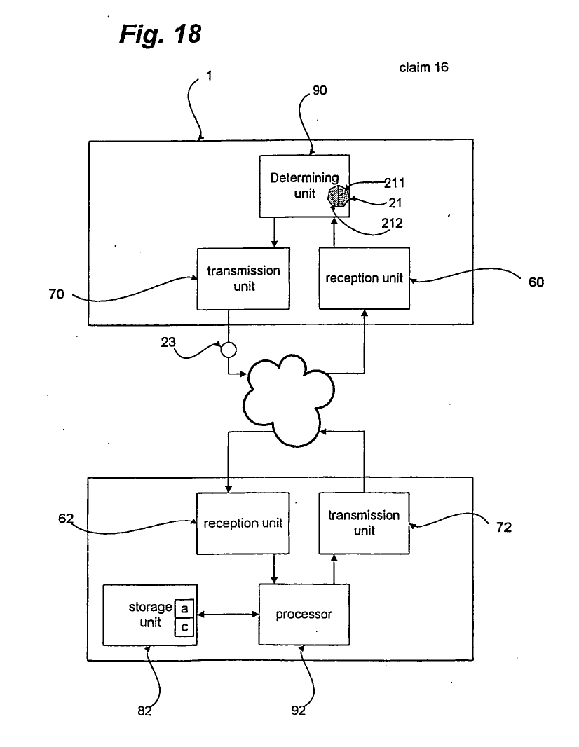

FIG. 18 shows a load balancing system according to a sixteenth embodiment of the present invention. In FIG. 18 is shown a further stage of the load balancing method described with reference to FIG. 16, in which on arrival at the network management processor 1, the processing load information collection message 21 causes the determining means 90 of the network management processor to determine on the basis of information collected from the processors of the network 4 through which the processing load information collection message 21 has passed, a load balancing technique for the network as a whole. Once the determining means 90 has determined which load balancing technique is to be adopted, it causes the transmission means 70 of the network management processor 1 to transmit an implementation message 23 via the network 4 to at least one of the processors 52 connected to the network 4, instructing it as to which load balancing method it is to adopt so as to conform with the selected load balancing technique. The processor 52 is provided with a storage means 82, in which may be stored load balancing method data A, C.

When the reception means 62 receives the implementation message 23, the implementation message is passed to the processor means 92, which then attempts to locate the load management method to which the implementation message 23 reefers in the storage means 82. Where this information is found in the storage means, the processor means 92 then implements this load balancing method. Each processor connected to the network may be sent a respective implementation message 23, such that throughout the network processors adopt the load balancing method necessary to conform with the load balancing technique for the network as a whole determined by the determining means 90 of the work management processor 1.

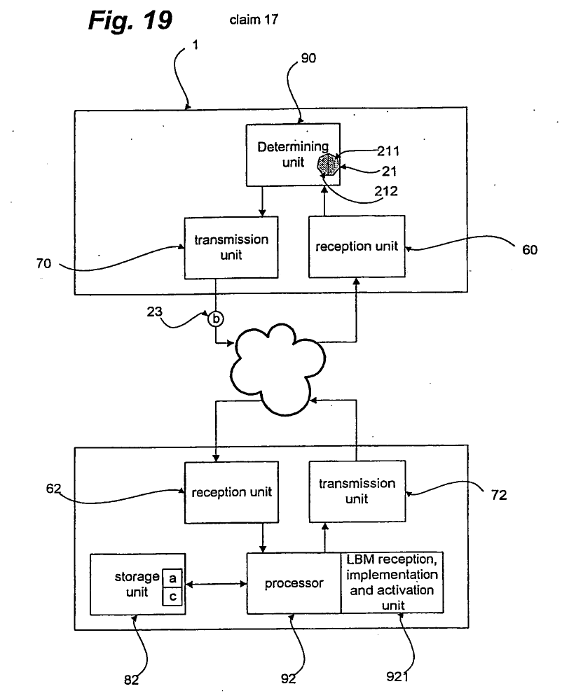

FIG. 19 shows a load balancing system according to a seventeenth embodiment of the present invention. In the embodiment of FIG. 19, the load balancing management system comprises all elements described with reference to FIG. 18. There is further provided in the processor means 92 of each processor 52 in the network 4, a load balancing method reception, implementation and activation means 921.

In the method described with reference to FIG. 18, it may occur that when the processor means 92 of the processor 52 receives the implementation 23, the load balancing method to which the implementation method refers is not found in the storage means 82. Where this is the case, the processor means may transmit a signal through the network 4 to the network management processor 1, indicating this to be the case. Where it is thus detected that a processor 52 does not have the load balancing method B required for the implementation of the load balancing technique selected by the determining means 90, the load balancing method B can be included with the implementation message 23 transmitted via the network 4 to the processor 52. The load balancing method reception implementation and activation means 91 of the processor 52 can then act so as to store the new load balancing method for example in the storage means 82, and implement load balancing method in the processor means 92.

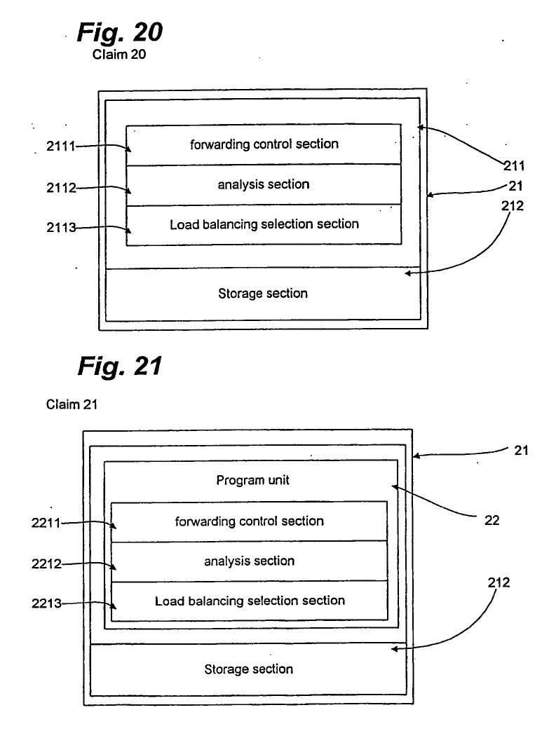

FIG. 20 shows a load balancing unit according to an eighteenth embodiment of the present invention. FIG. 20 shows details of the structure of the processing load information collection message. The processing load information collection message 21 comprises an instruction unit 211, and a storage unit 212 then instruction unit 211 itself comprises a forwarding control means 2111, an analysis means 2112, and a load balancing selection means 2113.

The forwarding control section 2111 contains information contains information intended to cause the network management processor 1 to issue the processing load information collection message 21 to a first processor connected to the network and then to cause each one of the plurality of processors connected to the network to pass the processing load information correction unit 21 to a further one of that plurality of processors respectfully, until the processing load information collection message arrives once more at the network management processor 1.

The analysis section 2112 contains information which will cause each processor to which the processing load information collection unit is transmitted to analyse its respective processing load, and to add the results of this analysis to the storage section 212.

The load balancing technique selection section 2113 contains information intended to prompt the network management processor to determine on the basis of the processing load information of the processors to which the processing load information collection unit has been transmitted, and stored in the storage section 2112 to determine a load balancing technique for load distribution among the processors connected to the processor network.

FIG. 21 shows a load balancing unit according to a nineteenth embodiment of the present invention. FIG. 20 shows details of the structure of the processing load information collection program unit 22. The processing load information collection program unit 22 comprises an instruction unit 221, and a storage unit 212 then instruction unit 221 itself comprises a forwarding control section 2211, an analysis section 2212, and a load balancing selection section 2213.

The forwarding control section 2211 contains a sequence of instructions which when operated on a processor will cause the network management processor 1 to issue the processing load information collection message 21 to a first processor connected to the network and then to cause each one of the plurality of processors connected to the network to pass the processing load information correction unit 21 to a further one of that plurality of processors respectfully, until the processing load information collection message arrives once more at the network management processor 1.

The analysis section 2212 contains sequence of instructions which when operated on a processor will cause the processor to analyse its respective processing load, and to add the results of this analysis to the storage section 212.

The load balancing technique selection section 2213 contains sequence of instructions which when operated on the network management processor will cause it to determine on the basis of the processing load information of the processors to which the processing load information collection unit has been transmitted, and stored in the storage section 2212 to determine a load balancing technique for load distribution among the processors connected to the processor network.

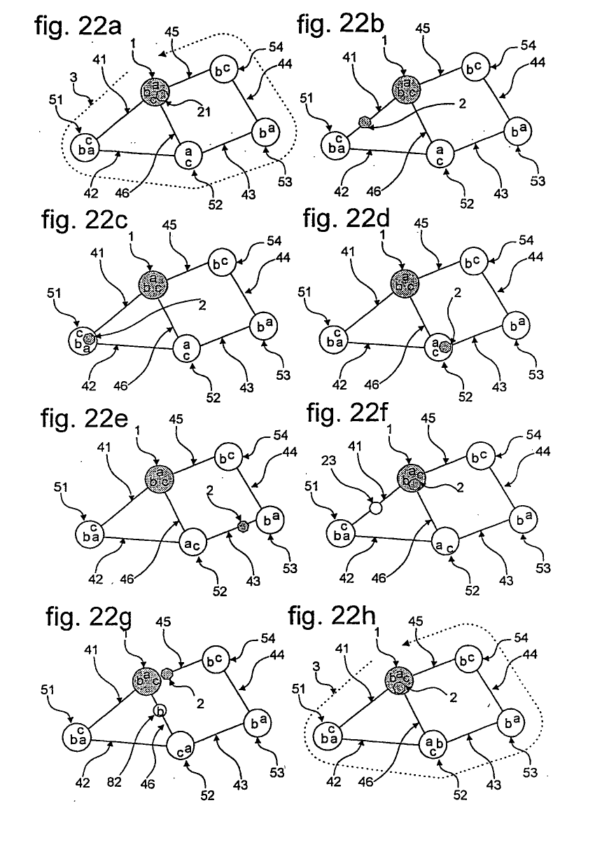

FIG. 22 shows a load balancing method according to a twentieth embodiment of the present invention. FIG. 22 is a step wise representation of the load balancing method according this embodiment of the invention.

In FIG. 22a, it is shown how, in a network comprising a network management processor 1, and further processors 51, 52, 53 and 54, connected in a network by connectors 41, 42, 43, 44, 45, and 46, a processing load information collection unit 21 is passed through the processors of the network along a predetermined route 3. As shown in FIG. 22a, each processor in the network has a selection of load balancing methods a, b, c installed.

In FIG. 22b, the processing load information collection unit 21 is passed from the network management processor 1 to a first processor 51, via the communication channel 41. On its arrival at the processor 51, as shown in FIG. 22c, the processing load information collection unit 21 causes the first processor 51 to analyse the processing load of the processor 51, and to add the results of this analysis to a storage section of the processing load information collection unit 21. As shown in FIGS. 22d and 22e, the processing load information collection unit 21 is then passed from processor to processor throughout the network, according to the predetermined path 3 shown in FIG. 22a. Finally, as shown in FIG. 22f, the processing load information collection message 21 arrives at the network management processor 1. The processing load information collection unit causes the network management processor 1 to determine on the basis of the processing load analysis information for each of the processors in the network visited by the accessing load information collection unit, what load balancing technique is best able to provide the load balancing conditions desired in the network as a whole. The network management processor then transmits an implementation message 23 to one or more of the processors, indicating which balancing method a, b, c should be adopted. In FIG. 22g, it is shown how where it is detected that a particular processor 52 does not have a required balancing method b, the balancing method b is transmitted with a further implementation method message 82 to the processor 52, where upon it is installed as shown in FIG. 22h in the process 52, such that the balancing method determined by the network management processor 1 as best coinciding with the network management technique determined therein is activated.

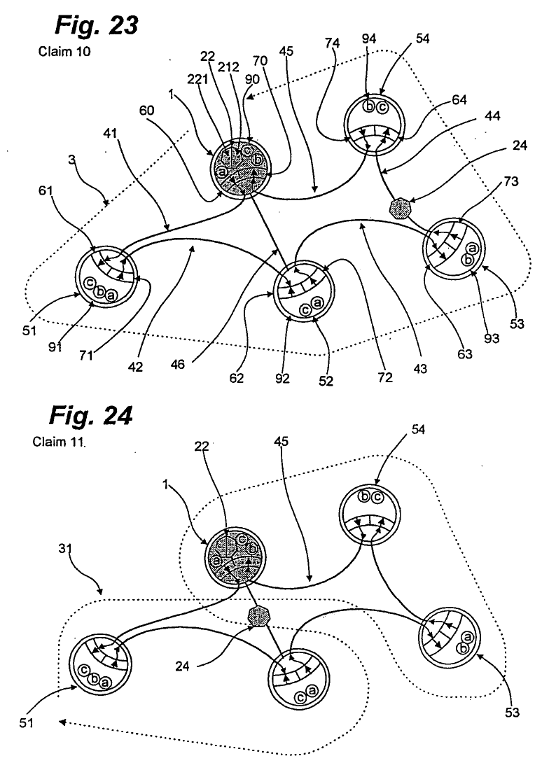

FIG. 23 shows a load balancing method according to a ninth embodiment of the present invention. FIG. 23 shows a system similar to that shown in for example FIG. 15, but is further provided with further processing load exploration program unit 24 in addition to a first processing load information unit 22.

FIG. 24 shows a load balancing method according to a tenth embodiment of the present invention. As shown in FIG. 24, the second accessing load exploration program unit 24 may move through the network according to a predetermined path 31, which may differ from the predetermined path 3 followed by the first processing load exploration program unit 22.

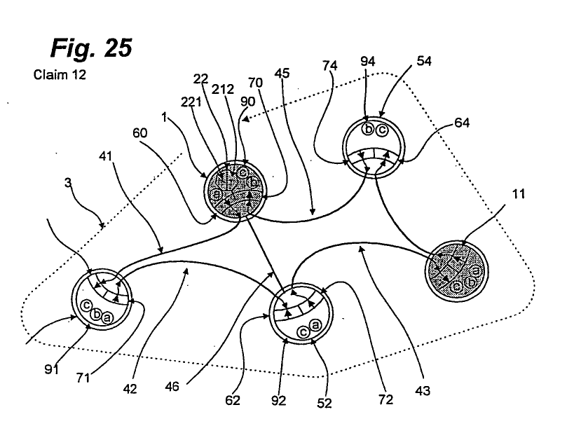

FIG. 25 shows a load balancing method according to an eleventh embodiment of the present invention. FIG. 25. According to this embodiment of the invention, the network may comprise a plurality of network management processors. Where this is the case, each network management processor may determine a load balancing technique for the network as a whole, or for a part of the network. The part of the network selected for load balancing technique control by a particular network management processor may be selected as those processors closest to this particular network management processor, or those processors having some other relation thereto. The predetermined path followed by the processing load exploration programming unit 22 may be selected so as to limit it to these processors. As shown in FIG. 25, there is provide a second network management processor 11.

1-27. (canceled)

28. A method for managing the respective processing loads of a plurality of processors in a processor network, comprising the steps of:
a first network management processor issuing a processing load information collection message to an adjacent processor;
said adjacent processor adding into the message its analyzed processing load information and forwarding said message to yet another processor of the processor network which repeats the adding and forwarding functions; wherein,
a processor forwards the message with the added processing load information to the first network management processor, which determines, on the basis of the processing load information of the processors stored in said processing load information collection message, a load balancing technique for load distribution among the processors in said processor network.

29. The method according to claim 28, in which said processing load information collection message is a first processing load exploration program unit, wherein said processing load exploration program unit analyses the respective processing: load of each of the processors to which it is forwarded and stores corresponding processing load information.

30. The method according to claim 29, wherein said first network management processor determines as said load balancing technique a respective load balancing method for each of said processors.

31. The method according to claim 30, wherein at least one of said processors has stored a plurality of load balancing methods and said first network management processor sends a load balancing method activation message to said at least one processor for activating the load balancing method determined for the processor.

32. The method according to claim 31, wherein, prior to said first network management processor sending said load balancing method activation message to said at least one processor for activating the load balancing method determined for the processor, said first network management processor determines whether said load balancing method determined for the processor is presently stored at said processor.

33. The method according to claim 31, wherein said first network management processor sends a load balancing method implementation message, including the respective determined load balancing method, and said at least one processor implements and activates said included load balancing method.

34. The method according to claim 29, wherein said first processing load exploration program unit determines at each processor whether the processor is a network management processor or not.

35. The method according to claim 29, wherein said first processing load exploration program unit is passed from processor to processor in accordance with a predetermined order of processors.

36. The method according to claim 29, wherein said first processing load exploration program unit is passed from processor to processor in a predetermined group of processors.

37. The method according to claim 29, wherein at least one further processing load exploration program unit is passed from processor to processor in parallel with said first processing load exploration program unit.

38. The method according to claim 37, wherein said first processing load exploration program unit and said further processing load exploration program unit are passed from processor to processor in different sequences.

39. The method according to claim 28, wherein said plurality of processors comprises at least one further network management processor.

40. A network including a network management processor and a plurality of networked processors and having incorporated a load balancing technique for managing processing loads amongst said networked processors, wherein:
a) a processing load information collection message is provided including an instruction unit for initiating an analysis of processing loads at a processor and a storage unit for storing processing load information about the analyzed processing loads;
b) each processor has a reception unit for receiving said processing load information collection message, a processor for running said received exploration program unit, and a transmission unit for forwarding said processing load information collection message to a next processor; and,
c) said network management processor has a transmission unit for transmitting said processing load information collection message to a first processor in the processor network, and a reception unit for receiving said processing load information collection message from a processor and a determining unit to determine, on the basis of the processing load information of the processors stored in said load exploration program unit storage section, a load balancing technique for load distribution among the processors in said processor network.

41. The network according to claim 40 wherein said processing load information collection message is a processing load exploration program unit, and said instruction unit of said processing load information collection message is an analysis program unit for performing an analysis of processing loads at a processor, and wherein said instruction unit of said processing load information collection message also causes the determining unit of said network management processor to determine said load balancing technique.

42. The network according to claim 41, wherein said network management processor has a determining unit to determine as said load balancing technique a respective load balancing method for each of said processors.

43. The network according to claim 41, wherein at least one of said processors has a storage unit to store a plurality of load balancing methods, and said network management processor is adapted to send a load balancing method activation message to said at least one processor for activating the load balancing method determined for the processor.

44. The network according to claim 41, wherein said network management processor has a transmission unit to send to at least one processor a load balancing method implementation message including the respective determined load balancing method, and said at least one processor has a receiver unit to receive an to implement and activate said included load balancing method.

45. The network according to claim 41, wherein said transmission unit and said reception unit of each of said processors respectively is adapted such that said processing load exploration program unit is passed from processor to processor in accordance with a predetermined order of processors.

46. The network according to claim 36, wherein said transmission unit and said reception unit of each of said processors respectively is adapted such that said processing load exploration program unit is passed from processor to processor in a predetermined group of processors.

47. A processing load information collection unit for use in the management of the respective processing loads of a plurality of processors networked in a processor network, said processing load exploration collection unit comprising:
storage section and instruction section, said instruction section comprising:
a) a forwarding control section to cause said network management processor to issue said processing load information collection message to a first one of said plurality of processors, and then to cause each one of said plurality of processors to pass said processing load information collection unit to a further one of said plurality of processors respectively until it arrives again at said network management processor;
b) an analysis section to analyze the respective processing load of each of said processors to which it is forwarded on its reception thereby, the results of each such analysis being stored in said storage section; and,
c) a load balancing technique selection section to cause said network management processor on its reception thereby to determine, on the basis of the processing load information of the processors stored in said storage section, a load balancing technique for load distribution among the processors in said processor network.

48. The processing load information collection unit according to claim 47, wherein said instruction section comprises a program unit which, when executed on the respective processors, is operative to:
a) cause said network management processor to issue said processing load information program unit to a first one of said plurality of processors, and then to cause each one of said plurality of processors to pass said processing load information program unit to a further one of said plurality of processors respectively until it arrives again at said network management processor;
b) analyze the respective processing load of each of said processors to which it is forwarded, the results of each such analysis being stored in said storage section; and,
c) cause said network management processor to determine, on the basis of the processing load information of the processors stored in said storage section, a load balancing technique for load distribution among the processors in said processor network.

49. The processing load information collection unit according to claim 48, wherein it causes said network management processor to determine, on the basis of the processing load information of the processors stored in said storage section, a load balancing technique for load distribution among the processors in said processor network, for each of said processors.

50. The processing load exploration program unit according to claim 48, wherein it further causes said network management processor, after said step of determining a load balancing technique, to send a load balancing method activation message to said at least one processor for activating the load balancing method determined for the processor.

51. The processing load exploration program unit according to claim 48, wherein it further causes said network management processor, after said step of determining a load balancing technique, to send to at least one processor a load balancing method implementation message including the respective determined load balancing method, and said at least one processor implements and activates said included load balancing method.

52. The processing load exploration program unit according to claim 48, wherein said processing load exploration program unit further has a determining unit to determine at each processor whether the processor is said network management processor or not.

53. The processing load exploration program unit according to claim 48, wherein said instruction section is adapted to cause each one of said plurality of processors to pass said processing load exploration program unit to a further one of said plurality of processors respectively in accordance with a predetermined order of processors.

54. The processing load exploration program unit according to claim 48, wherein said instruction section is adapted to cause each one of said plurality of processors to pass said processing load information collection message to a further one of said plurality of processors respectively in a predetermined group of processors.
